(19) United States
(12) Patent Application Publication
(10) Pub. No.: US 2015/0256363 A1
(43) Pub. Date: Sep. 10, 2015

(54) Integrated PAM4/NRZ N-Way Parallel Digital Unrolled Decision Feedback Equalizer (DFE)

(71) Applicant: LSI Corporation, San Jose, CA (US)

(72) Inventors: Volodymyr Shvydun, Los Altos, CA (US); Adam B. Healey, Newburyport, MA (US); Chaitanya Palusa, Fremont, CA (US)

(73) Assignee: LSI Corporation, San Jose, CA (US)

(21) Appl. No.: 14/226,915

(22) Filed: Mar. 27, 2014

Related U.S. Application Data
(60) Provisional application No. 61/947,595, filed on Mar. 4, 2014.

(51) Int. Cl. H04L 25/03; H04L 25/49

(52) U.S. Cl. CPC H04L 25/03057; H04L 25/4917; H04L 25/49

(57) ABSTRACT

An N-way parallel, unrolled decision feedback equalizer for a SerDes receiver can convert between four-tap PAM-2 and two-tap PAM-4 mode, maximizing hardware through the use of mode control multiplexers. Each of N interleaved parallel branches includes an ISI correction stage for generating a partial result approximating intersymbol interference and comparing the partial result to a threshold, a carry look-ahead stage for generating a second partial result based in part on previously generated partial results, and a decision feedback stage for generating a final decision based on previous branches. Mode control multiplexers can select from PAM-2 and PAM-4 operating modes, PAM-2 and MAP-4 inputs at various stages, or from single-bit PAM-2 and two-bit PAM-4 outputs. ISI correction can additionally be reformulated to incorporate comparing raw input symbols to a combination of approximated ISI and a threshold.

### CROSS-REFERENCE TO RELATED APPLICATIONS

This application claims priority under 35 U.S.C. §119(e) to provisional patent application U.S. Ser. No. 61/947,595, filed on Mar. 4, 2014. Said application is hereby incorporated by reference herein in its entirety.

### TECHNICAL FIELD

Embodiments of the invention relates generally to the field of digital filters in communication channels, and particularly to receiver equalization in a serializer/deserializer (SerDes) receiver device.

### BACKGROUND

For generations of electrical standards below 10 GB/s the incumbent signaling method is non-return-to-zero (NRZ), otherwise known as two-level pulse-amplitude modulation (PAM-2, see FIG. 1). The popular perception is that four-level pulse-amplitude modulation (PAM-4, see FIG. 2) signaling enables use of, and interconnectivity with, legacy backplanes. It is commonly accepted that a decision feedback equalizer (DFE) offers the best balance of maximal performance and minimal hardware for correcting inter-symbol interference (ISI) caused by previously transmitted symbols in a data communications channel.

Generally, a DFE will adapt feedback from previously detected symbols to the equalization of currently detected symbols. For example, a number of previously decoded symbols may be multiplied by coefficients, or taps, to approximate ISI and then subtracted from the received symbol. An unrolled DFE may eliminate or “unroll” the feedback loop partially or fully by precomputing all possible ISI approximations based on received symbol history, with the correct product selected by multiplexer. Such an unrolled DFE can be configured to process either single-bit PAM-2 symbols or two-bit PAM-4 symbols, but the former configuration may waste hardware processing single-bit symbols. It may therefore be desirable for a decision feedback equalizer to support both PAM-2 and PAM-4 signaling, but with the available hardware in PAM-2 configuration being optimally used to implement double the number of DFE taps as possible in PAM-4 configuration.

### SUMMARY

Embodiments of the invention are directed to high-speed N-way parallel fully unrolled decision feedback equalizers (DFEs) with interoperability between NRZ/PAM-2 and PAM-4 signaling modulation schemes for maximum utilization of hardware. Embodiments of a DFE according to the invention can include N interleaved parallel branches, each branch configured to combine received PAM-2 or PAM-4 input symbols with coefficients generated from previously decoded input symbols, generate a first decision by comparing the result to a threshold voltage, generate partial results based on the first decision and previously generated partial results, and selecting a final output based on the partial results via multiplexer. Interoperability between PAM-2 and PAM-4 input symbols can be controlled by a series of multiplexers selecting the appropriate set of threshold voltages, coefficients, partial results, or output values. In some embodiments, PAM-2/PAM-4 interoperability can be controlled by a single multiplexer configured to select the mode of operation. In some embodiments, an ISI correction stage can be reconfigured to compare raw input symbols to a combination of a threshold voltage and precomputed approximations of inter-symbol interference to save area and clock time.

### BRIEF DESCRIPTION OF THE DRAWINGS

Embodiments of the invention may be better understood by those skilled in the art by reference to the accompanying figures in which:

FIG. 1A is an illustration of a NRZ/PAM-2 eye diagram;

FIG. 1B is an illustration of a PAM-4 eye diagram;

FIG. 2 is a block diagram of a generic decision feedback equalizer;

FIG. 3 is a block diagram of a generic decision device;

FIG. 4 is a block diagram of a generic combiner, a 4:1 multiplexer, and a 2:1 multiplexer;

FIG. 5A is a block diagram of a decision feedback equalizer with multiplexer loop;

FIG. 5B is a block diagram of a decision feedback equalizer with multiplexer loop;

FIG. 6 is a block diagram of an interoperable decision feedback equalizer with multiplexer loop according to the invention;

FIG. 7A is a block diagram of a fully unrolled decision feedback equalizer;

FIG. 7B is a block diagram of a fully unrolled decision feedback equalizer;

FIG. 8 is a block diagram of a fully unrolled decision feedback equalizer with reformulated slicer according to the invention;

FIG. 9A is a block diagram of a fully unrolled interoperable decision feedback equalizer according to the invention; and

FIG. 9B is a block diagram of a parallel branch of a fully unrolled interoperable decision feedback equalizer according to the invention.

### DETAILED DESCRIPTION OF THE DRAWINGS

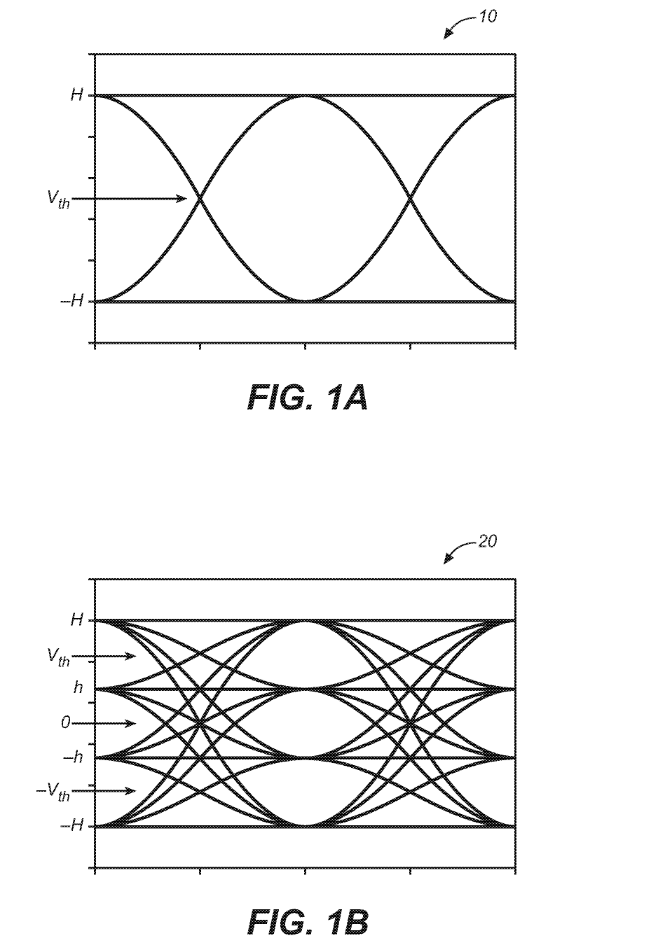

FIGS. 1A and 1B respectively depict NRZ/PAM-2 eye diagram to and PAM-4 eye diagram 20. PAM-2 signaling provides for two possible analog voltage levels {H, −H}, each corresponding to a single-bit transmitted value ({+1, −1} maps to {1, 0}), and a single data slicer threshold (ex.—threshold voltage) corresponding to zero. PAM-4 signaling provides for four analog voltage levels {H, h, −h, −H}, corresponding to four Gray-coded two-bit combinations ({+1, +1/3, −1/3, −1} maps to {01, 00, 10, 11}) and three slicer thresholds (+Vₜₕ=2/3, 0, −Vₜₕ=−2/3).

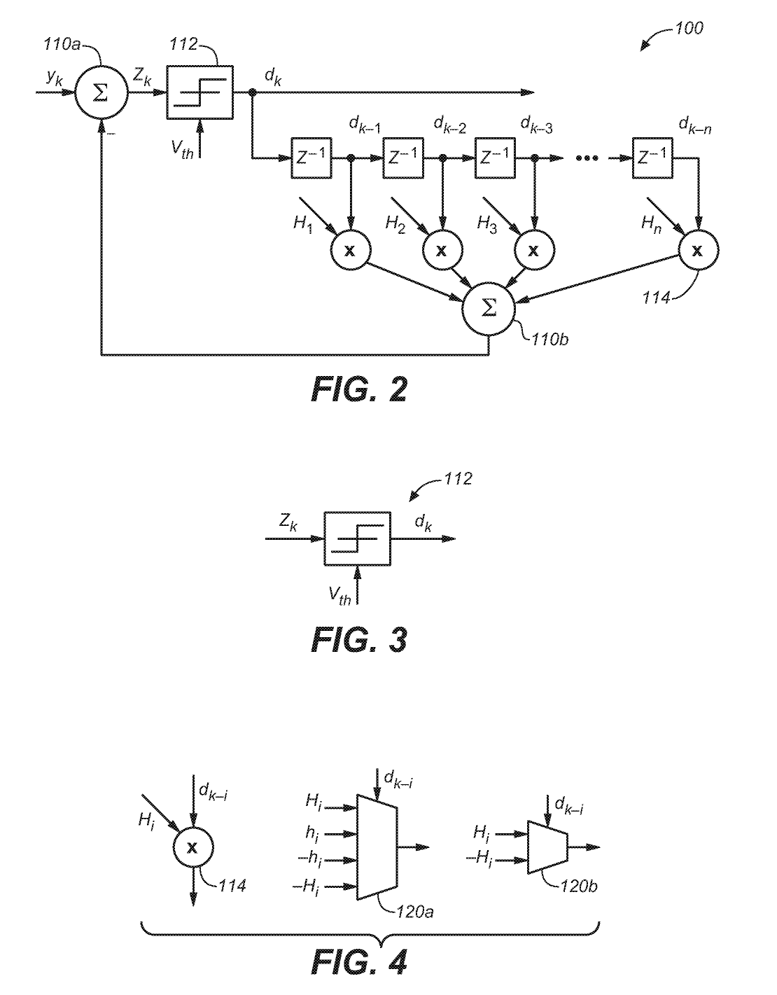

FIG. 2 depicts a generic n-tap decision feedback equalizer (DFE) 100. Embodiments of generic DFE 100 can derive from an input symbol yₖ received by DFE 100 (e.g., from a feed forward equalizer) the value zₖ, which can be expressed as

$${z}_{k} = {y}_{k} - {\sum }_{i = 1}^{n} {d}_{k - i} \times {H}_{i}$$

where dₖ₋₁ represents feedback from the previously detected input symbol yₖ₋₁.

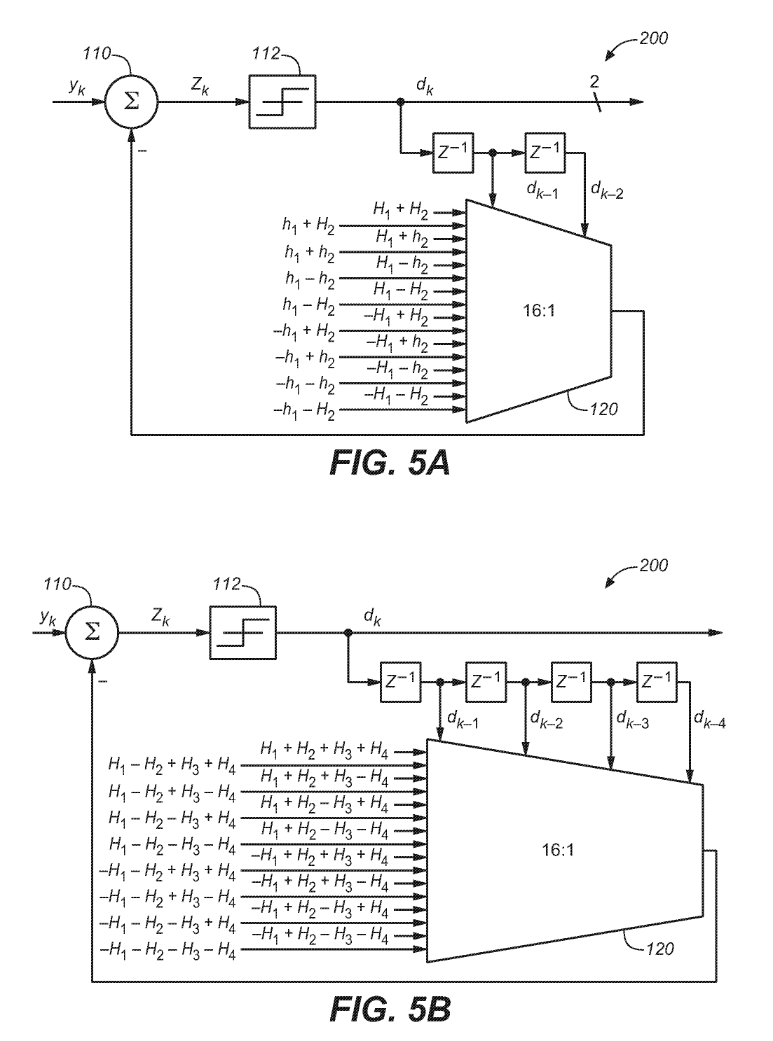

FIG. 3 depicts slicer (ex.—comparator, decision device) 112 of DFE 100. After subtracting (via combiner 110) an H-product Hᵢ (to approximate ISI) from yₖ based on n previously detected symbols, slicer 112 compares zₖ to threshold voltage Vₜₕ and makes a decision (e.g., logic 1 or logic 0) with respect to final output symbol dₖ. For implementing high speed decision feedback equalization, the multiplication of dₖ₋ᵢ×Hᵢ can be substituted with precomputation and selection by multiplexer to reduce propagation delay associated with analog switching, “unrolling” the feedback loop 110 of DFE 100. DFE loop computation can be reformulated based on look-ahead techniques where outputs for all possible Hᵢ/hᵢ are precomputed and the correct output then selected by multiplexer (ex.—mux). For example, in PAM-4 signaling environments, the values of hᵢ=Hᵢ/3, −Hᵢ, and −hᵢ are pre-calculated. DFE slicer 112 can then determine dₖ: if zₖ>Vₜₕ then dₖ=01; if zₖ>0 then dₖ=00; if zₖ>−Vₜₕ then dₖ=10; otherwise (zₖ<−Vₜₕ) dₖ=11. In PAM-2 environments slicer 112 makes a similar but simpler determination: if zₖ>0 then dₖ=00/01 (as PAM-2 signals are single-bit, the least significant bit is forced); otherwise (zₖ<0) dₖ=10/11.

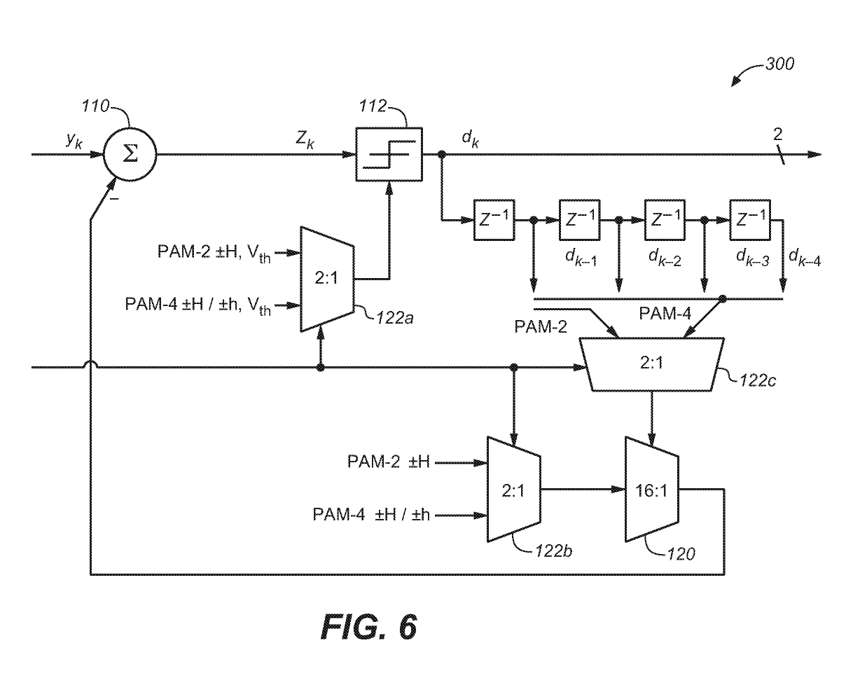

FIG. 4 depicts multiplier 114 and multiplexers 120a, 120b. In PAM-2 mode, the single-tap ISI calculation (dₖ₋ᵢ×±Hᵢ) performed by multiplier 114 has two possible values {(dₖ₋ᵢ×Hᵢ)} and can therefore be implemented as 2:1 multiplexer 120b, which selects from the two possible values. In PAM-₄ mode, the single-tap ISI calculation of multiplier 114 has four possible values {(dₖ₋ᵢ×hᵢ), (dₖ₋ᵢ×−Hᵢ), (dₖ₋ᵢ×−hᵢ); hᵢ=Hᵢ/3} and can therefore be implemented as 4:1 multiplexer 120a. Additionally, the double-tap PAM-2 ISI calculation (dₖ₋ᵢ×±Hᵢ)+(dₖ₋ᵢ₋₁×±Hᵢ₊₁) also has four possible values

$$\{ \begin{matrix}( {d}_{k - i} \times {H}_{i} ) + ( {d}_{k - i - 1} \times {H}_{i + 1} ) , ( {d}_{k - i} \times {H}_{i} ) + ( {d}_{k - i - 1} \times - {H}_{i + 1} ) , \\ ( {d}_{k - i} \times - {H}_{i} ) + ( {d}_{k - i - 1} \times {H}_{i + 1} ) , ( {d}_{k - i} \times - {H}_{i} ) + ( {d}_{k - i - 1} \times - {H}_{i + 1} ) ,\end{matrix} \}$$

and, similarly to its single-tap PAM-4 counterpart, can also be implemented as 4:1 multiplexer 120a.

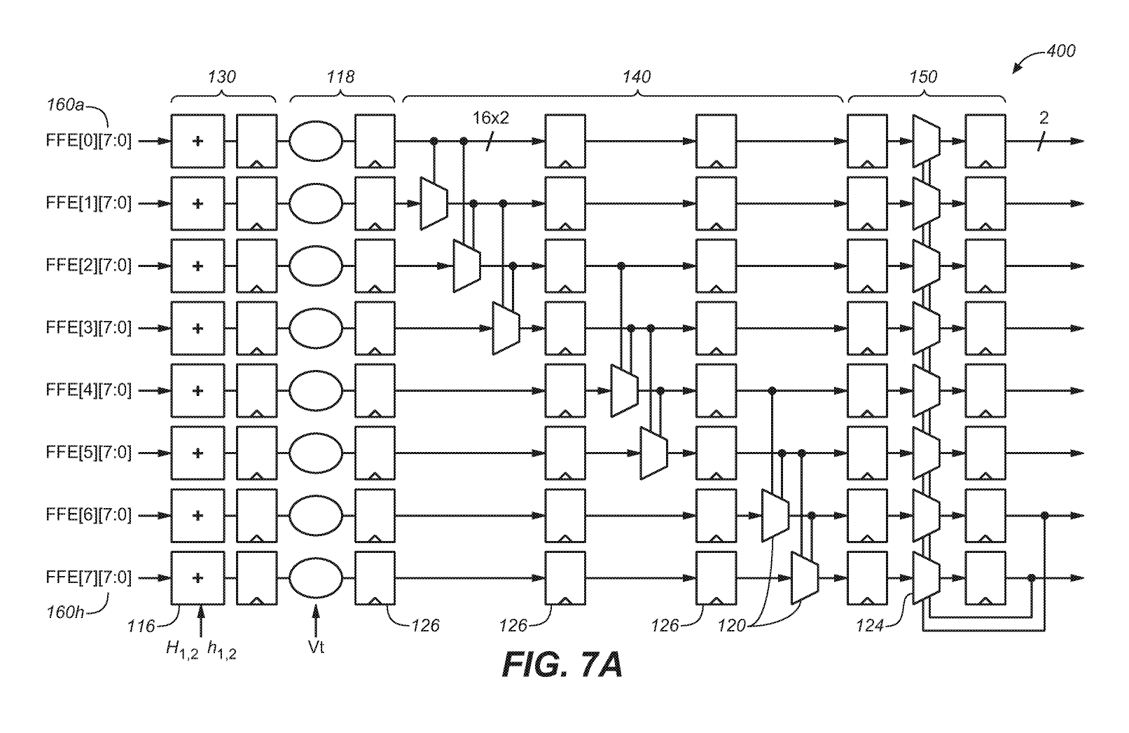

FIGS. 5A and 5B respectively depict a two-tap PAM-4 decision feedback equalizer 200 and a four-tap PAM-2 decision feedback equalizer 200. In PAM-4 mode, the double-tap ISI calculation has 2²⁺²=16 possible values

$$\{ \begin{matrix}( {d}_{k - i} \times \pm {H}_{i} ) + ( {d}_{k - i - 1} \times \pm {H}_{i + 1} ) , ( {d}_{k - i} \times \pm {H}_{i} ) + ( {d}_{k - i - 1} \times \pm {h}_{i + 1} ) , \\ ( {d}_{k - i} \times \pm {h}_{i} ) + ( {d}_{k - i - 1} \times \pm {H}_{i + 1} ) , ( {d}_{k - i} \times \pm {h}_{i} ) + ( {d}_{k - i - 1} \times \pm {h}_{i + 1} ) ,\end{matrix} \}$$

and thus DFE 200 requires 16:1 multiplexer 120 to implement. In PAM-2 mode, however, these same components (combiner 110, slicer 112, 16:1 multiplexer 120) can support four taps. Here multiplexer 120 also selects from 16 possible values

{(dₖ₋ᵢ×±H₁)+(dₖ₋ᵢ₋₁×±H₂)+(dₖ₋ᵢ₋₂×±H₃)+(dₖ₋ᵢ₋₃×±H₄)}.

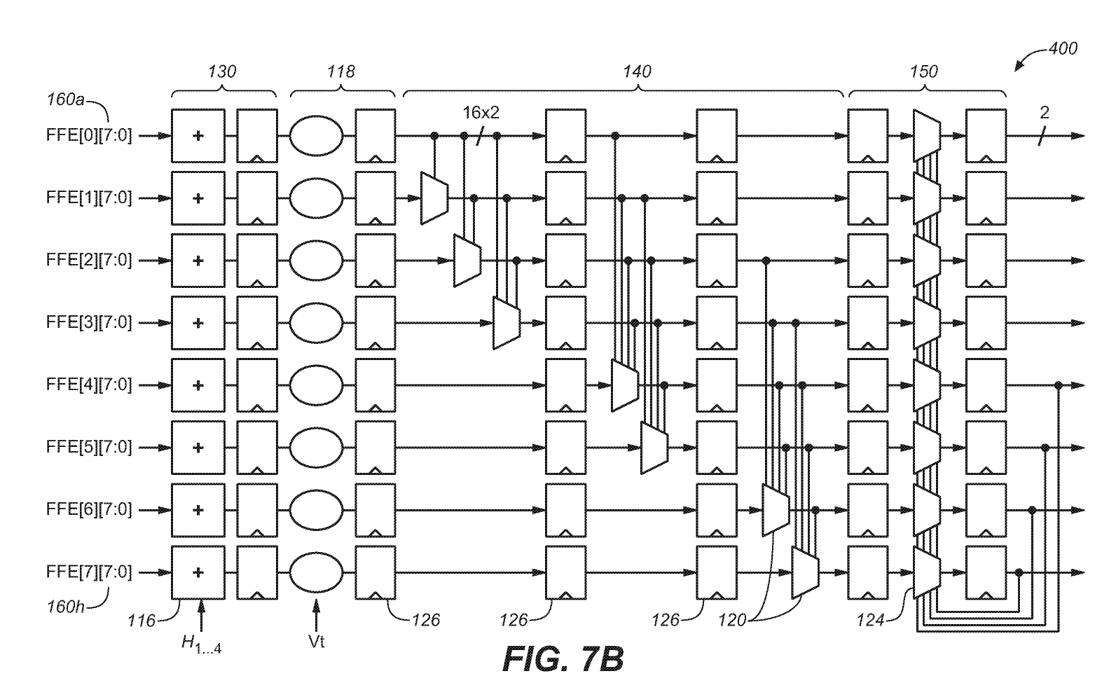

FIG. 6 depicts an embodiment of a DFE 300 capable of interchangeably processing PAM-2 or PAM-4 signals according to the invention. In embodiments slicer 112, when implemented as part of a one-way parallel, two-tap, PAM 4 mode DFE 200 with a 16:1 multiplexer loop (120-110) as shown in FIG. 5A, can output a two-bit value as previously outlined. In PAM-2 mode embodiments of DFE 200 (as shown in FIG. 5B), however, slicer 112 outputs only a single-bit value, which would waste hardware: a two-tap PAM-2 DFE requires only 2¹⁺¹=4 possible ISI approximations {Hᵢ+hᵢ, Hᵢ−hᵢ, −Hᵢ+hᵢ, −Hᵢ+hᵢ} as opposed to 2²⁺²=16 possible ISI approximations for a two-tap PAM-4 DFE.

Embodiments of interoperable DFE 300 therefore increase PAM-2 signal processing performance and maximize hardware utilization by extending the PAM-2 DFE 300 from two-tap to four tap. As previously noted, DFE 200 would require only a 4:1 multiplexer for two-tap PAM-2 processing rather than the 16:1 multiplexer 120 incorporated by DFE 300 for two-tap PAM-4 processing. Therefore embodiments of DFE 300 can utilize four taps in PAM-2 mode (which could be accommodated by 16:1 multiplexer 120) without adding hardware or wasting the multiplexer. Mode control can be provided by a series of 2:1 multiplexers 122a, 122b, 122c for selecting PAM-2 or PAM-4 input (e.g., voltage thresholds, values of H/h, taps, H-products).

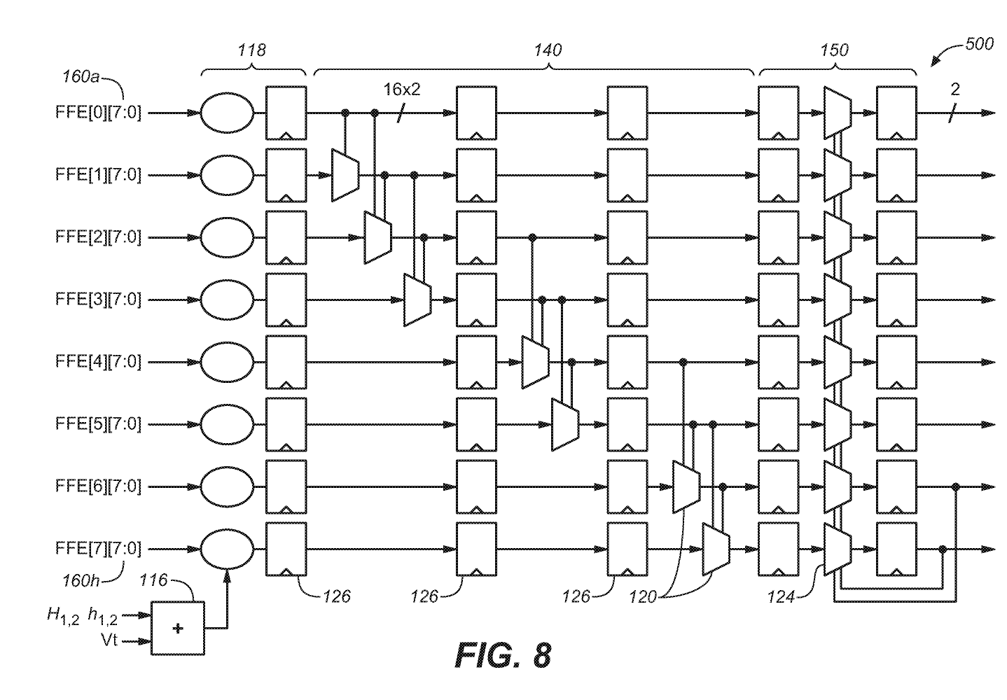

FIGS. 7A and 7B depict embodiments of 8-way parallel decision feedback equalizer 400 configured for, respectively, two-tap PAM-4 and four-tap PAM-2 operation. The DFE feedback loop (as shown in FIGS. 2, 5A, 5B, and 6) limits the upper bound of achievable speed in hardware implementation. In other words, DFE throughput is limited by the speed of the feedback loop. Embodiments of DFE 400 can implement high speed decision feedback equalization by “unrolling” the loop: each parallel branch 160a . . . 160h can incorporate loop-up tables or tree structures where a pre-computed ISI approximation

$${\sum }_{i = 1}^{n} {d}_{k - i} \times {H}_{i}$$

can be generated at ISI correction stage 130 by adder banks 116 and then compared to threshold voltages Vₜₕ by decision devices 118. Carry look-ahead stage 140, including multiplexers 120, conditions the input to decision feedback stages 150 based on the inputs of previous parallel branches 160. Multiple pipeline stages (ex.—latches, flip-flops) 126 allow the multiple interleaved branches 160a . . . 160h to operate simultaneously. The speed limitations imposed by feedback loops are mitigated, and can be implemented by transformation techniques using nested multiplexer loops.

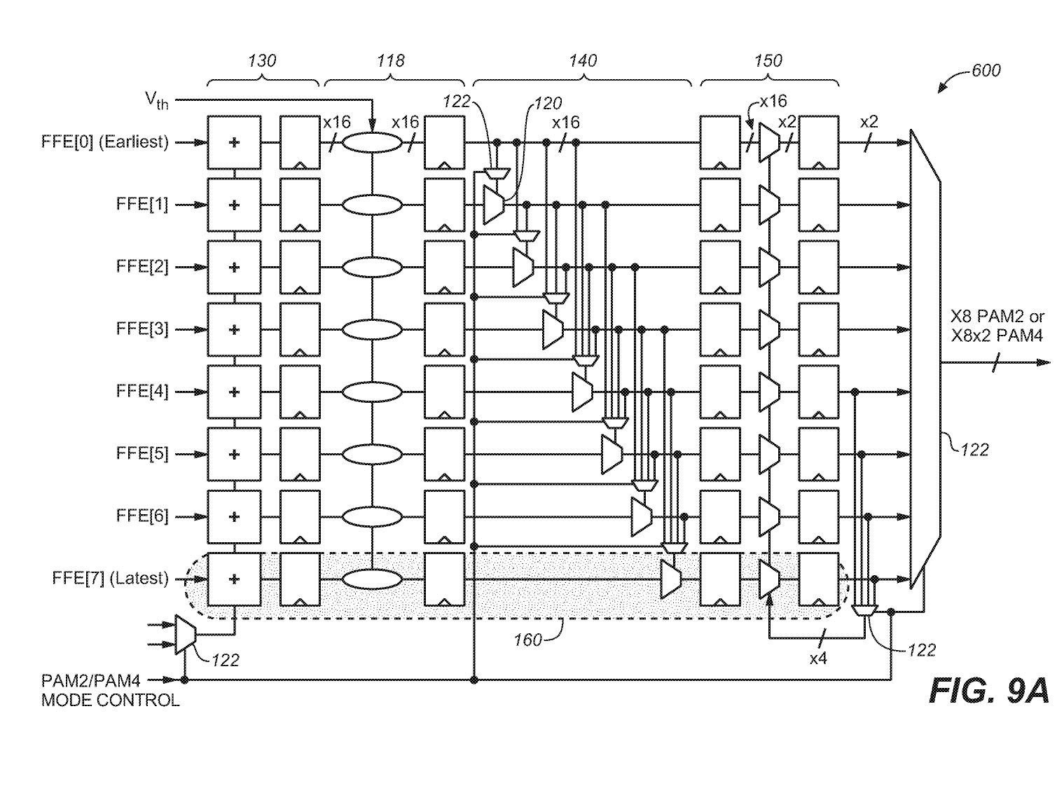

FIG. 8 depicts an embodiment 500 of an 8-way parallel, 2-tap, PAM-4 DFE 500 with reformulated slicer 118. FIG. 7B illustrates an embodiment of an 8-way parallel, 4-tap, PAM-2 DFE using identical hardware to the embodiment illustrated in FIG. 7A. Embodiments of DFE 500 as shown by FIG. 8 may further conserve area and reduce latency by reformulating DFE slicer 118 of ISI correction stage 130. Given the slicing function

$${z}_{k} = {y}_{k} - ISI ; where ISI = {\sum }_{i = 1}^{n} {d}_{k - i} \times {H}_{i}$$

it can be observed that dₖ₋ᵢ (i=1 to n) can be precomputed by carry look-ahead stage 140. As previously shown, high speed DFE implementations can also precompute values of Hᵢ and hᵢ. Therefore, embodiments of DFE 500 can conserve space and reduce latency by removing multiple combiner blocks 116 from ISI correction stage 130 (one block 116 of 16 combiners, as opposed to one block for each parallel branch 160a . . . 160h) and transforming the slicer function. Instead of calculating zₖ by subtracting the correct ISI approximation from received symbol yₖ, reformulated DFE slicers 118 can compare yₖ to the precomputed sum of approximate ISI (±H_{1 . . . n}, ±h_{1 . . . n}) and threshold voltage Vₜₕ. For example, a slicer function employed by DFE 400 as shown in FIGS. 7A and 7B, where slicer function

$$\{ \begin{matrix}If ( {z}_{k} > {V}_{th} ) then {d}_{k} = 01 ; else if ( {z}_{k} > 0 ) then {d}_{k} = 00 ; \\ else if ( {z}_{k} > - {V}_{th} ) then {d}_{k} = 10 ; else {d}_{k} = 11\end{matrix}$$

can be transformed into the reformulated slicer function

$$\{ \begin{matrix}If ( {y}_{k} > ( {V}_{th} + {ISI}_{k} ) ) then {d}_{k} = 01 ; else if ( {y}_{k} > ( 0 + {ISI}_{k} ) ) then {d}_{k} = 00 ; \\ else if ( {y}_{k} > - ( {V}_{th} + {ISI}_{k} ) ) then {d}_{k} = 10 ; else {d}_{k} = 11\end{matrix}$$

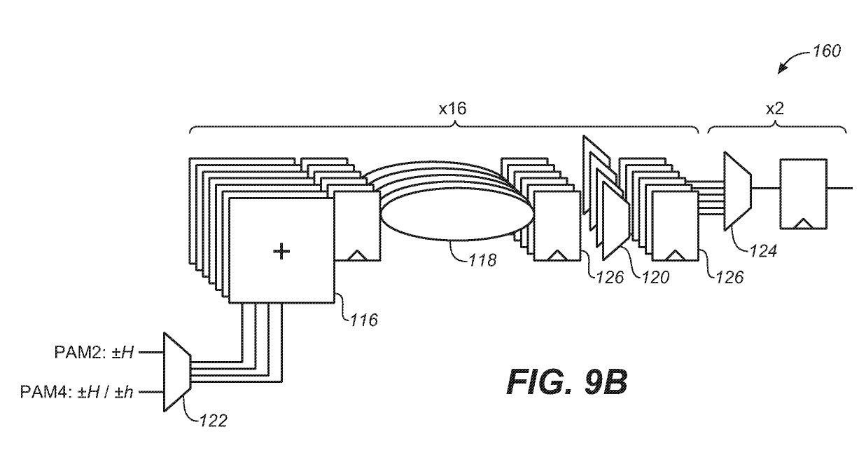

FIG. 9A depicts an embodiment of an interoperable (two-tap PAM-4/four-tap NRZ) 8-way parallel DFE 600 according to the invention, wherein interoperability can be implemented through the incorporation of additional mode control multiplexers 122. For example, 2:1 mode control multiplexer 122a (also shown in FIG. 9B, depicting parallel branch 160) may select the appropriate ISI components based on PAM-2 (±H) or PAM-4 (±H, ±h) operation. Similarly, additional multiplexers 122b at the carry look-ahead stage 140 can select from one of 16 possible H-products in either four-tap PAM-2 mode (i.e., a three-level carry look-ahead stage):

{(dₖ₋ᵢ×±Hᵢ)+(dₖ₋ᵢ₋₁×±Hᵢ₊₁)+(dₖ₋ᵢ₋₂×±Hᵢ₊₂)+(dₖ₋ᵢ₋₃×±Hᵢ₊₃)}

or two-tap PAM-4 mode (i.e., a one-level carry look-ahead stage):

$$\{ ( {d}_{k - i} \times \{ \begin{matrix}\pm {H}_{i} \\ \pm {h}_{i}\end{matrix} ) + ( {d}_{k - i - 1} \times \{ \begin{matrix}\pm {H}_{i + 1} \\ \pm {h}_{i + 1}\end{matrix} ) \} .$$

Additional multiplexers 122c following the decision feedback stage 150 (or single 16:1 multiplexer 122d) may allow selection between two-bit PAM-4 and one-bit PAM-2 output from each parallel branch 160. In some embodiments, a single 2:1 mode control multiplexer 122 may control input to multiplexers and provide interoperability between PAM-2 and PAM-4 mode. Embodiments of DFE 600 can also incorporate a reformulated slicer function as shown in FIG. 8.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

We claim:

1. A system for generating equalized output symbols by applying decision feedback equalization to received single-bit PAM-2 and two-bit PAM-₄ input symbols, comprising:
a plurality of interleaved sequential branches, each interleaved branch including
(a) a correction stage including a plurality of correction blocks, each block configured to generate a first partial result by combining the received input symbol with at least one tap, the tap generated by multiplying a previously decoded input symbol by a predetermined coefficient, and a plurality of decision devices, each decision device operably coupled to a correction block and configured to generate a first decision result by comparing the first partial result to a predetermined threshold voltage,
(b) a carry look-ahead stage configured to generate at least one second partial result based on at least one of a first decision result and a second partial result generated by a previous branch, and
(c) a decision feedback stage including at least one multiplexer configured to select a final decision result from the at least one second partial result, and
(d) at least one pipeline structure configured to store at least one of a first partial result, a first decision result, a second partial result, and a final decision result; and
at least one multiplexer configured to select at least one final decision result from a first plurality of PAM-2 final decision results and a second plurality of PAM-4 final decision results generated by the plurality of branches.

2. The system of claim 1, further comprising:
at least one multiplexer configured to select at least one of a PAM-2 operating mode and a PAM-4 operating mode.

3. The system of claim 1, further comprising:
at least one multiplexer configured to select at least one of a PAM-2 coefficient and a PAM-4 coefficient;
at least one multiplexer configured to select at least one of a first plurality of PAM-2 taps and a second plurality of PAM-4 taps.

4. The system of claim 3, wherein the at least one multiplexer configured to select at least one of a first plurality of PAM-2 taps and a second plurality of PAM-4 taps includes at least one multiplexer configured to select at least one of a set of four PAM-2 taps and a set of two PAM-4 taps.

5. The system of claim 1, wherein the system is an 8-way parallel decision feedback equalizer having 8 branches.

6. The system of claim 1, wherein each decision device is at least one of a comparator or a slicer.

7. The system of claim 1, wherein the at least one multiplexer includes a multiplexer loop.

8. The system of claim 1, wherein the correction stage includes
a plurality of decision devices, each decision device configured to generate a first decision result by comparing the received input symbol to a combination of a predetermined threshold voltage with at least one tap, the tap generated by multiplying a previously decoded input symbol by a predetermined coefficient.

9. The system of claim 1, wherein the system is embodied in a serializer/deserializer (SerDes) receiver device.

10. A method for generating equalized output symbols by applying decision feedback equalization to received single-bit PAM-2 and two-bit PAM-4 input symbols, comprising:
selecting an operating mode from a group including PAM-2 mode and PAM-4 mode;
generating at least one first partial result by combining at least one received input symbol with at least one tap, the at least one tap generated by multiplying a previously decoded input symbol by a predetermined coefficient;
generating at least one first decision result by comparing the first partial result to a predetermined threshold voltage;
generating a plurality of second partial results based on the at least one first decision result and a previously generated second partial result; and
generating at least one final decision result based on the plurality of second partial results.

11. The method of claim to, wherein selecting an operating mode from a group consisting of PAM-2 mode and PAM-4 mode includes selecting an operating mode from a group consisting of PAM-2 mode and PAM-4 mode via at least one multiplexer.

12. The method of claim to, wherein selecting an operating mode from a group consisting of PAM-2 mode and PAM-4 mode includes
selecting at least one of a PAM-2 coefficient and a PAM-4 coefficient via at least one multiplexer;
selecting at least one of a first plurality of PAM-2 taps and a second plurality of PAM-4 taps via at least one multiplexer; and
selecting at least one final decision result from a first plurality of PAM-2 final decision results and a second plurality of PAM-4 decision results via at least one multiplexer.

13. The method of claim 12, wherein selecting at least one of a first plurality of PAM-2 taps and a second plurality of PAM-4 taps via at least one multiplexer includes selecting at least one of a set of four PAM-2 taps and a set of two PAM-4 taps via at least one multiplexer.

14. The method of claim 10, wherein generating at least one first decision result by comparing the first partial result to a predetermined threshold voltage includes
generating a first decision result by comparing the at least one received input symbol to a combination of a predetermined threshold voltage with at least one tap, the tap generated by multiplying at least one previously decoded input symbol by a predetermined coefficient.

15. The method of claim 10, wherein the method is embodied in instructions executable by at least one of a processor and a circuit operably coupled to a serializer/deserializer (SerDes) receiver.
